(19) United States
(12) Patent Application Publication
(10) Pub. No.: US 2007/0116509 A1
(43) Pub. Date: May 24, 2007

(54) Collapsible squeeze tube

(76) Inventor: Robert Lin, Hsin-Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/327,503

(22) Filed: Jan. 9, 2006

(30) Foreign Application Priority Data
Nov. 18, 2005 (TW) 94220024

(51) Int. Cl. B05C 11/00; B43K 1/06; B43M 11/06

(52) U.S. Cl. 401/266; 401/265; 401/183

(57) ABSTRACT

A collapsible squeeze tube having a soft buffer member with a spout hole formed integral with and covered on the front side of the head in front of the collapsible tube body thereof for buffering flowing of the contained fluid material that is squeezed out of the collapsible tube body and the head by the user for application.

### BACKGROUND OF THE INVENTION

1. Field of the Invention

The present invention relates to collapsible tubes and more particularly, to a collapsible squeeze tube.

2. Description of the Related Art

Many kinds of fluid materials such as toothpaste, liquid cosmetics, shoe oil, and etc., are packed in collapsible squeeze tubes for easy carrying and application. A collapsible squeeze tube for this purpose generally comprises a collapsible tube body and a head at the front side of the collapsible tube body. The head has a spout hole for output of the contained fluid material. When squeezing the collapsible squeeze tube of a collapsible lip color squeeze tube and moving the head of the collapsible lip color squeeze tube over the lips to apply the contained fluid lip color to the skins, it is difficult to keep the round head of the collapsible lip color squeeze tube in close touch with the lips without giving much pressure to the lips. Further, when squeezing the collapsible tube body during application, the contained fluid lip color may overflow, thereby causing a contamination.

FIGS. 1 and 2 show a collapsible squeeze tube according to the prior art. According to this design, the collapsible squeeze tube comprises a collapsible tube body 10, and a head 20 at the front side of the collapsible tube body 10. The head 20 has a beveled front face 21 and a center spout hole 22. The beveled front face 21 allows close contact of the head 20 with the user's skin when applying the contained fluid material to the user's skin. However, because the head 20 has a certain hardness, the fluid material may flow over the beveled front face 21 and the periphery of the head 20 when it is squeezed out of the head 20 for application, resulting in a contamination or application inconvenience.

FIGS. 3 and 4 show another structure of collapsible squeeze tube according to the prior art. According to this design, the collapsible squeeze tube 10 has a bristle head 32 that buffers the application of the output fluid material. This design prevents an overflow of the applied fluid material. However, the bristle head 32 is complicated to process and greatly increases the cost of the collapsible squeeze tube 10. Further, the bristle head 32 wears quickly with use and tends to gather microbes.

### SUMMARY OF THE INVENTION

The present invention has been accomplished under the circumstances in view. It is the main object of the present invention to provide a collapsible squeeze tube, which buffers the output of the contained fluid material for comfortable application. It is another object of the present invention to provide a collapsible squeeze tube, which is practical for application to substitute for a collapsible squeeze tube having a bristle head.

To achieve these and other objects of the present invention, the collapsible squeeze tube comprises a collapsible tube body carrying a fluid material, the collapsible tube body having a rear end sealed and a front end defining an opening for output of the fluid carried therein; a head fixedly provided at the front end of the collapsible tube body, the head defining a spout hole for guiding the fluid material out of the collapsible tube body; and a soft buffer member covered on a front side of the head remote from the tube body and adapted to buffer flowing of the fluid material out of the spout hole of the head when the collapsible tube body is squeezed by a person, the soft buffer member having a spout hole in communication with the spout hole of the head for guiding said fluid material out of the head.

### BRIEF DESCRIPTION OF THE DRAWINGS

FIG. 1 is a side elevation of a collapsible squeeze tube according to the prior art.

FIG. 2 is a longitudinal view in section of the collapsible squeeze tube of FIG. 1.

FIG. 3 is a side elevation of another structure of collapsible squeeze tube according to the prior art.

FIG. 4 is a longitudinal view in section of the collapsible squeeze tube of FIG. 3.

FIG. 5 is a side elevation of a first embodiment of a collapsible squeeze tube in accordance with the present invention.

FIG. 6 is a longitudinal view in section of the first embodiment of the collapsible squeeze tube in accordance with the present invention.

FIG. 7 is a side elevation of a second embodiment of a collapsible squeeze tube in accordance with the present invention.

FIG. 8 is a longitudinal view in section of the second embodiment of the collapsible squeeze tube in accordance with the present invention.

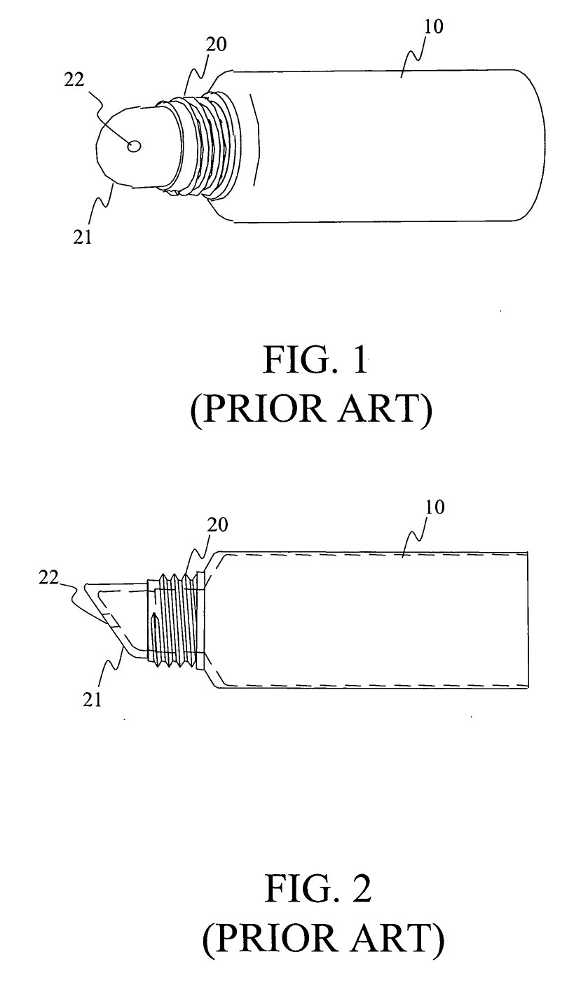

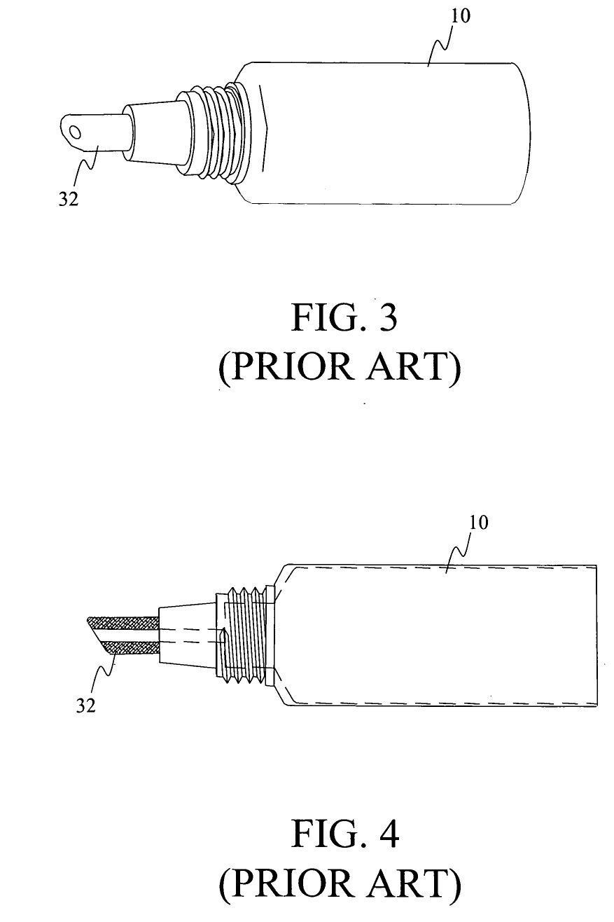

### DETAILED DESCRIPTION OF THE PREFERRED EMBODIMENT

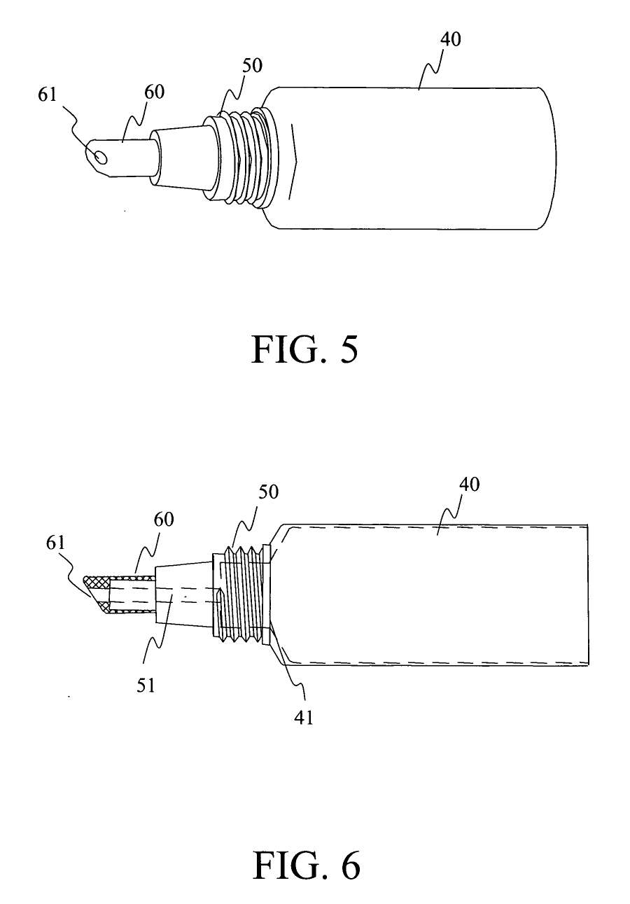

Referring to FIGS. 5 and 6, a first embodiment of a collapsible squeeze tube in accordance with the present invention is shown comprising a collapsible tube body 40, a head 50, and a soft buffer member 60. The collapsible tube body 40 is adapted to hold a fluid material, having one end, namely, the rear end sealed and the other end, namely, the front end defining an opening 41 for output of the fluid carried therein. The head 50 is formed integral with the periphery of the front end of the collapsible tube body 40 around the opening 41, defining an axially extending center spout hole 51 in communication with the opening 41 of the collapsible tube body 40. The soft buffer member 60 is a soft covering formed integral with and covered on the front side of the head 50, having a spout hole 61 in axial alignment with the spout hole 51 of the head 50 for guiding the contained fluid from the collapsible tube body 40 out of the opening 41 of the collapsible tube body 40 and the spout hole 51 of the head 50.

According to the aforesaid first embodiment of the present invention, the soft buffer member 60 is formed integral with and covered on the front side of the head 50 remote from the collapsible tube body 40. The soft buffer member 60 can be molded from a food grade plastic material suitable for carrying foods or cosmetics. Because of the soft material characteristic, the soft buffer member 60 buffers the flowing speed of the contained fluid when the user is squeezing the collapsible tube body 40 to force the contained fluid out of the head 50.

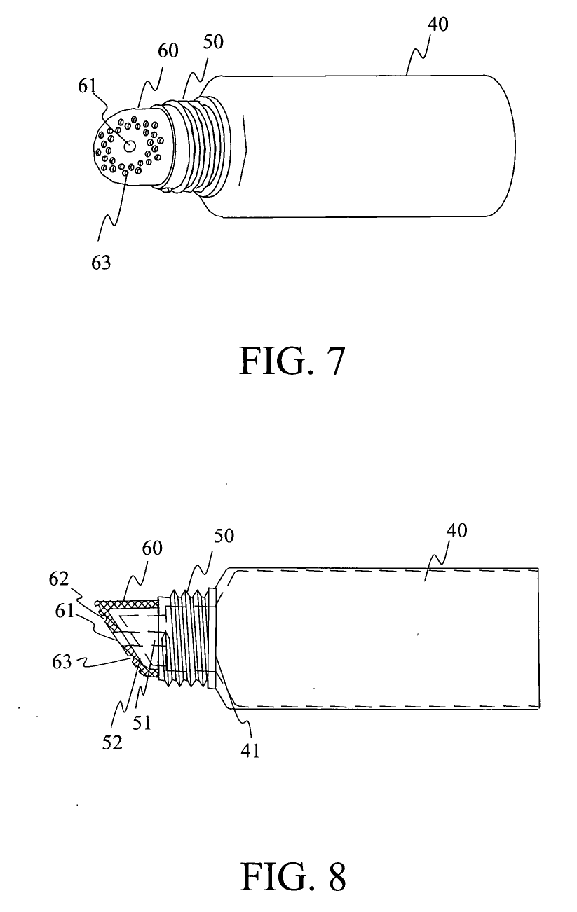

FIGS. 7 and 8 show a second embodiment of a collapsible squeeze tube in accordance with the present invention. This embodiment is substantially similar to the aforesaid first embodiment with the exception that the head 50 has a beveled front edge 52, and the soft buffer member 60 has also a beveled front face 62 fitting over the beveled front edge 52 of the head 50. This design is suitable for the application of a makeup, for example, a fluid lip color. When moving the beveled front face 62 over the user's lips to apply the contained fluid lip color, the beveled front face 62 of the soft buffer member 60 gives a soft touch. Therefore, the user can apply the contained liquid lip color to the lips comfortably. Further, plural of recessed holes 63 may be defined in the beveled front face 62 of the soft buffer member 60 around the spout hole 61 for receiving an overflow of the fluid that has been squeezed out of the collapsible tube body 40 when the user is applying the fluid to the skin.

As indicated above, the prevent invention provides a collapsible squeeze tube, which has a soft buffer member at the front side to buffer the application of the applied fluid material. The soft buffer member can be directly molded on the head of the collapsible squeeze tube. Because this processing process is simple, the soft buffer member does not increase much the manufacturing cost. Further, recessed holes may be made in the front side of the soft buffer member to receive an overflow of the applied fluid material, preventing a contamination.

Although particular embodiments of the invention have been described in detail for purposes of illustration, various modifications and enhancements may be made without departing from the spirit and scope of the invention.

What is claimed is:

1. A collapsible squeeze tube comprising:
a collapsible tube body carrying a fluid material, said collapsible tube body having a rear end sealed and a front end defining an opening for output of the fluid carried therein;
a head fixedly provided at the front end of said collapsible tube body, said head defining a spout hole for guiding said fluid material out of said collapsible tube body; and
a soft buffer member covered on a front side of said head remote from said tube body and adapted to buffer flowing of said fluid material out of the spout hole of said head when said collapsible tube body is squeezed by a person to force said fluid material out of said head, said soft buffer member having a spout hole in communication with the spout hole of said head for guiding said fluid material out of said head.

2. The collapsible squeeze tube as claimed in claim 1, wherein said head is formed integral with the front end of said collapsible tube body.

3. The collapsible squeeze tube as claimed in claim 1, wherein said soft buffer member is formed integral with said head.

4. The collapsible squeeze tube as claimed in claim 1, wherein said soft buffer member has a plurality of recessed holes in a front side thereof around the spout hole of said soft buffer member.
